(19) United States
(12) Patent Application Publication
(10) Pub. No.: US 2015/0153608 A1
(43) Pub. Date: Jun. 4, 2015

(54) DISPLAY MODULE AND DISPLAY DEVICE

(71) Applicant: Sharp Kabushiki Kaisha, Osaka-shi, Osaka (JP)

(72) Inventor: Kazuya Kondoh, Osaka-shi (JP)

(21) Appl. No.: 14/404,047

(22) PCT Filed: Apr. 23, 2013
(86) PCT No.: PCT/JP2013/061941

§ 371 Date: Nov. 26, 2014

(30) Foreign Application Priority Data
Jun. 1, 2012 (JP) 2012-125963

(51) Int. Cl. G02F 1/1345; G02F 1/1333

(52) U.S. Cl. CPC G02F 1/13452; G02F 1/133308

(57) ABSTRACT

When a display panel and/or a circuit substrate, for example, is thermally expanded or contracted, the invention prevents damage, such as breaking of a substrate that connects the display panel with the circuit substrate or snapping of lines on that substrate. A line substrate (140), which is flexible, connects a display panel (10) with a circuit substrate (160) that is located substantially level with the panel. One edge of the line substrate (140) is connected with the display panel (10), while another, opposite edge is connected with the circuit substrate (160). A driver (142) is provided on the line substrate (140) for driving the display panel (10) and includes a first flexible region (141a) and a second flexible region (141b). When the line substrate (140) is connected with the display panel (10) and circuit substrate (160), the first flexible region (141a) and second flexible region (141b) are bent such that the portion of the line substrate on which the driver (142) is provided protrudes toward the front of the display panel (10).

### TECHNICAL FIELD

The present invention relates to a display module and a display device, or more particularly, to a technique to connect a display panel with a circuit substrate in a flat manner, i.e. connect a display panel with a circuit substrate such that their upper surfaces are substantially level with each other.

### BACKGROUND ART

JP Hei7(1995)-146656 A discloses that a display panel and a circuit substrate for controlling the operation of the display panel are connected in a flat manner via an insulating tape film. An LSI is mounted on the insulating tape film. JP 2002-76559 A discloses a flexible substrate having a semiconductor device mounted on its front side and including rolled-up portions at opposite edges thereof. Each rolled-up portion is folded onto the back side of the flexible substrate to form a U-shape. JP 2002-76559 A describes that one of the rolled-up portions of the flexible substrate is connected with the liquid crystal panel, while the other rolled-up portion is connected with a printed circuit board that is positioned to be level with the liquid crystal panel. Then, the semiconductor device on the flexible substrate is positioned to protrude higher than the liquid crystal panel and printed circuit board. JP 2002-76559 A employs this construction to reduce the distance between the liquid crystal panel and printed circuit board to minimize the breadth of the picture frame.

### DISCLOSURE OF THE INVENTION

In a display device such as a liquid crystal display, elements such as the display panel or circuit substrates may be thermally expanded or contracted due to changes in the internal temperature. When these elements are thermally expanded or contracted, stress may be applied to a substrate that connects the display panel with a circuit substrate in a flat manner, which may damage that substrate or even break it up.

An object of the present invention is to provide a technique to prevent damage to a line substrate that connects the display panel with a circuit substrate in a flat manner.

A display module according to the present invention includes: a display panel; a circuit substrate positioned to be substantially level with the display panel; a line substrate, the line substrate being flexible, the line substrate having one edge connected with the display panel and an opposite edge connected with the circuit substrate; and a driver provided between the one edge and the opposite edge of the line substrate for driving the display panel, wherein, in a connection state in which the line substrate is connected with the display panel and the circuit substrate, a first flexible region between the one edge and the driver and a second flexible region between the opposite edge and the driver are bent and a portion of the line substrate on which the driver is located protrudes toward a front of the display panel.

The arrangement of the present invention will prevent damage to a line substrate that connects the display panel with a circuit substrate in a flat manner.

### BRIEF DESCRIPTION OF THE DRAWINGS

FIG. 1 is a schematic view of the front side of the display device of a first embodiment.

FIG. 2 is a schematic cross-section of the display device taken along line A-A of FIG. 1.

FIG. 3 is a schematic view of the display device of FIG. 1 without the bezel.

FIG. 4 is a schematic diagram illustrating elements connected with the display panel of the first embodiment.

FIG. 5 is a schematic view of the display device of the first embodiment with the source substrates displaced toward the display panel.

FIG. 6A is a schematic cross-section of the display panel of a second embodiment.

FIG. 6B schematically illustrates how the source driver of FIG. 6A may be warped downwardly.

FIG. 7 is a schematic cross-section of the display device of a third embodiment.

FIG. 8 is a schematic cross-section of the display device of a variation in (2).

FIG. 9 is a schematic cross-section of the display device of the variation in (6).

### EMBODIMENTS FOR CARRYING OUT THE INVENTION

A display module according to an embodiment of the present invention may include: a display panel; a circuit substrate positioned to be substantially level with the display panel; a line substrate, the line substrate being flexible, the line substrate having one edge connected with the display panel and an opposite edge connected with the circuit substrate; and a driver provided between the one edge and the opposite edge of the line substrate for driving the display panel, wherein, in a connection state in which the line substrate is connected with the display panel and the circuit substrate, a first flexible region between the one edge and the driver and a second flexible region between the opposite edge and the driver are bent and a portion of the line substrate on which the driver is located protrudes toward a front of the display panel (first arrangement). In the present arrangement, when the display panel and/or a circuit substrate is displaced due to thermal expansion or contraction, the line substrate follows this displacement. This will prevent the line substrate form being broken or lines provided on the line substrate from snapping.

In a second arrangement, starting from the first arrangement, a rib may be provided below the portion of the line substrate on which the driver is located and between the display panel and the circuit substrate. In this arrangement, the rib prevents the driver portion from protruding toward the back side of the display panel. This will prevent heat generated from other electronic circuit components on the back side of the display panel from damaging the driver.

In a third arrangement, starting from the second arrangement, the rib may be provided so as to have its upper surface located substantially level with the display panel and the circuit substrate.

In a fourth arrangement, starting from one of the first to third arrangements, the display panel may be sandwiched by a first frame element covering an outer periphery of a front side of the display panel and a second frame element covering an outer periphery of a back side of the display panel and, in the connection state, the driver portion may be in contact with the first frame element. This arrangement allows heat generated by the driver to be dissipated to the first frame element.

In a fifth arrangement, starting from the fourth arrangement, the first frame element may include a recessed portion positioned to correspond to the driver portion with a front side that is recessed and a back side that protrudes toward a back of the display panel and, in the connection state, the driver portion may be in contact with the back side of the recessed portion. In this arrangement, heat generated by the driver may be dissipated to the first frame element.

In a sixth arrangement, starting from one of the second to fourth arrangements, the rib may be formed integrally with the second frame element. In this arrangement, the direction in which the driver portion protrudes may be adjusted without adding to the number of components.

In a seventh arrangement, starting from one of the first to sixth arrangements, the circuit substrate may transmit a signal from a control circuit to the line substrate and the driver may have a source circuit configured to supply a data signal based on the signal from the circuit substrate to the display panel via a first connection terminal.

An eighth arrangement, starting from the seventh arrangement, may include a gate circuit substrate connected with the display panel and configured to supply a scan signal based on a signal from the control circuit to the display panel.

A display device according to an embodiment of the present invention may include: a control circuit configured to provide a signal for driving the display panel; and one of the first to eighth arrangements (ninth arrangement). In this arrangement, when the display panel and/or the circuit substrate is displaced due to thermal expansion or contraction, the line substrate follows this displacement. This will prevent the line substrate from being damaged, thereby preventing a display failure.

Now, embodiments of the present invention will be described in detail with reference to drawings. The same or corresponding elements in the drawings are labeled with the same numerals and their description will not be repeated.

### First Embodiment

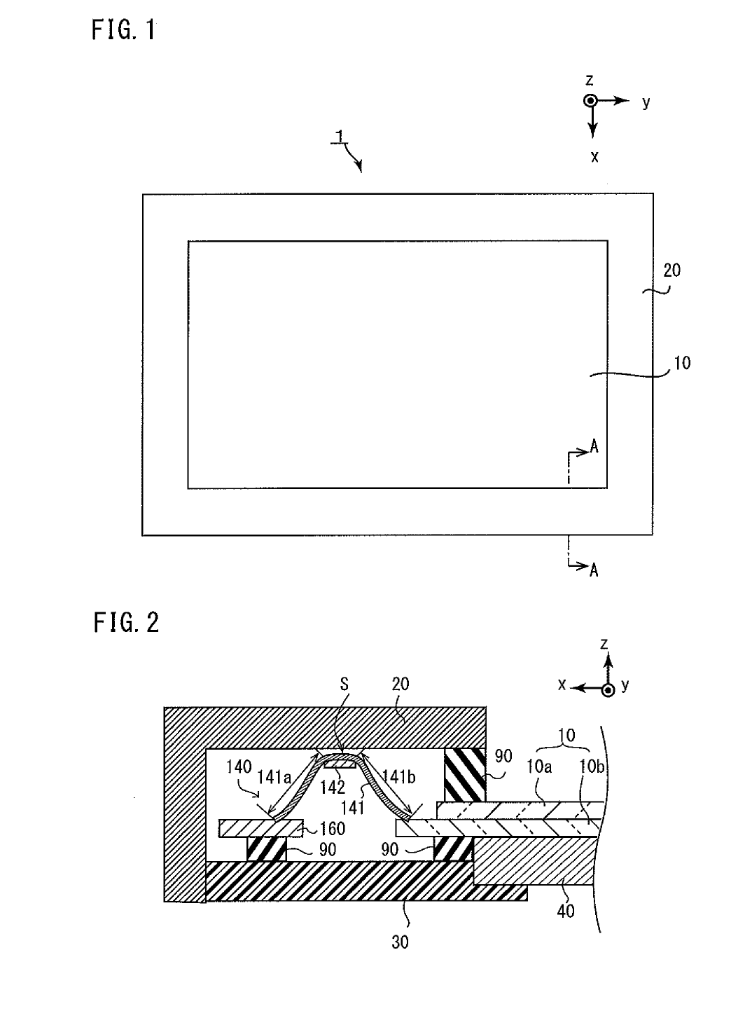

An embodiment of the present invention will be described below with reference to FIGS. 1 to 5. FIG. 1 shows the front side of a display device of the present invention. FIG. 2 shows a portion of the cross-section taken along line A-A of FIG. 1. As shown in FIGS. 1 and 2, the outer periphery of the front side, i.e. the side toward the positive direction of the z axis, of the display panel 10 of the display device 1 is covered with a bezel 20 made of metal. As shown in FIG. 2, the display panel 10 includes a color filter substrate 10a having a transparent substrate such as glass, and an active-matrix substrate 10b. A liquid crystal layer (not shown) is enclosed between the color filter substrate 10a and active-matrix substrate 10b. Thin-film transistors and pixel electrodes are provided on the side of the active-matrix substrate 10b adjacent the liquid crystal layer. Source lines 10s (FIG. 4) are connected with the source electrodes of the thin-film transistors. Gate lines 10g (FIG. 4) are connected with the gate electrodes of the thin-film transistors. A counter electrode is provided on the side of the color filter substrate 10a adjacent the liquid crystal layer and is positioned to face the pixel electrodes. Color filters are provided and positioned to correspond to the pixels. A polarizer (not shown) is provided on the side of the color filter substrate 10a that is opposite the side thereof adjacent the liquid crystal layer, while another polarizer (not shown) is provided on the side of the active-matrix substrate 10b that is opposite the side thereof adjacent the liquid crystal layer.

A backlight 40 is located below the active-matrix substrate 10b and is supported by the chassis 30. The backlight 40 includes a plurality of light-emitting diodes (LEDs) that constitute a light source. A buffer 90 formed of an elastic material such as rubber is provided on the back side of the active-matrix substrate 10b, while a similar buffer 90 is provided on the front side of the color filter substrate 10a. The display panel 10 is sandwiched by the bezel 20 (first frame element) and the chassis 30 (second frame element), with the respective buffers 90 interposed in between.

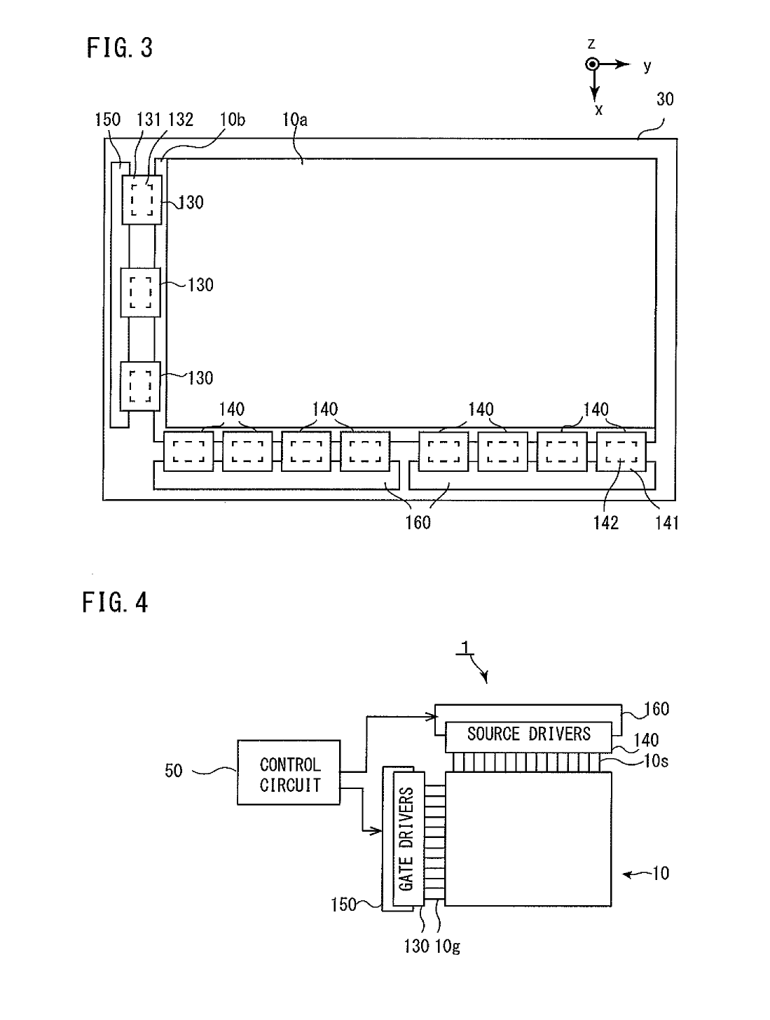

Next, various elements connected with the display panel 10 will be described. FIG. 3 shows the display device of FIG. 1 without the bezel 20. FIG. 4 is a block diagram showing elements connected with the display panel 10. As shown in FIG. 3, gate drivers 130 are connected with one short side (extending in an x direction) of the active-matrix substrate 10b, the gate drivers being connected with the gate lines 10g (FIG. 4). Source drivers 140 (examples of line substrates) are connected with a long side (extending in a y direction), which is located adjacent that short side, the source drivers being connected with the source lines 10s (FIG. 4).

A control circuit 50 is electrically connected with a gate substrate 150 and source substrates 160. The control circuit 50 includes a central processing unit (CPU) and memory, i.e. a read-only memory (ROM) and a random-accessing memory (RAM). Based on image data that has been input, the control circuit 50 supplies the gate substrate 150 with timing signals for driving the display panel 10 and supplies the source drivers 140 with data signals that make up image data.

The gate substrate 150 is a printed board having electronic components such as capacitors, resistors and diodes mounted thereon. The gate substrate 150 has an external connection terminal (not shown) connected with the control circuit 50 and terminals (not shown) connected with the gate drivers 130. The gate substrate 150 has lines (not shown) for transmitting signals from the control circuit 50 to the gate drivers 130. The timing signals fed into the control circuit 50 via the external connection terminal is transmitted to the gate drivers 130 through the lines and terminals.

The source substrates 160 are fixed on the buffer 90 on the chassis 30 so as to be substantially level with the active-matrix substrate 10b of the display panel 10. Each source substrate 160 is a printed board having electronic components such as capacitors, resistors and diodes mounted thereon. The source substrate 160 has an external connection terminal (not shown) connected with the control circuit 50 and terminals connected with the associated source drivers 140 (not shown). The source substrate 160 has lines (not shown) for transmitting signals from the control circuit 50 to the associated source drivers 140. The data signals fed into the substrate from the control circuit 50 via the external connection terminal are transmitted to the associated source drivers 140 through the lines and terminals.

As shown in FIG. 3, each gate driver 130 has an IC chip 132 provided on a film base 131. The film base 131 is made of a flexible material such as polyimide. The edge of the film base 131 adjacent the active-matrix substrate 10b has a connection terminal (not shown) connected with the active-matrix substrate 10b. The edge of the film base 131 opposite the edge adjacent the active-matrix substrate 10b has a connection terminal (not shown) connected with the gate substrate 150. Lines (not shown) are provided between the connection terminals for transmitting signals that are input to and output from the IC chip 132. The gate driver 130 may be a tape carrier package (TCP), a chip on film (COF), or a system on film (SOF). Each of the connection terminals of the gate driver 130 is pressed onto a connection terminal on the active-matrix substrate 10b or the gate substrate 150 via an anisotropic conductive film. Based on timing signals provided by the gate substrate 150, the IC chip 132 sequentially provides scan signals to the associated gate line 10g.

Each source driver 140 has an IC chip 142 (driver) provided on a film base 141. The film base 141 is made of a flexible material such as polyimide. The edge of the film base 141 adjacent the active-matrix substrate 10b has a connection terminal (not shown) connected with the active-matrix substrate 10b. The edge of the film base 141 that is opposite the edge adjacent the active-matrix substrate 10b has a connection terminal (not shown) connected with the associated source substrate 160. Lines (not shown) are provided between the connection terminals for transmitting signals that are input to and output from the IC chip 142. The source driver 140 may be a TCP, COF or SOF. Each of the connection terminals of the source driver 140 is pressed onto a connection terminal on the active-matrix substrate 10b or the associated source substrate 160 via an anisotropic conductive film. The IC chip 142 receives a data signal from the associated source substrate 160, converts it to a voltage signal, and provides it to the associated source line 10s in sync with a scan signal output from a gate driver 130.

As shown in FIG. 2, each film base 141 includes a first flexible region 141a and a second flexible region 141b. The first flexible region 141a extends from the edge of the base connected with the associated source substrate 160 to the edge of the IC chip 142 adjacent the source substrate 160. The second flexible region 141b extends from the edge of the base connected with the active-matrix substrate 10b to the edge of the IC chip 142 adjacent the active-matrix substrate 10b.

In the present embodiment, when the source drivers 140 are connected with the active-matrix substrate 10b and source substrates 160, the first and second flexible regions 141a and 141b for a given driver are bent so as to be curved. The portion of the side S of the source driver 140 that is opposite the portion of the side thereof on which the IC chip 142 is provided (hereinafter referred to as IC chip 142 portion) protrudes toward the bezel 20, i.e. toward the front of the display panel 10 without contacting the bezel 20.

That is, the length of the source driver 140 as measured in the x direction (first flexible region+second flexible region+IC chip 142 portion) is greater than the distance between the source substrate 160 and active-matrix substrate 10b. The source substrates 160 have a higher linear expansion coefficient than the active-matrix substrate 10b. As such, if the source substrates 160 and/or active-matrix substrate 10b are thermally expanded or contracted due to changes in the temperature inside the display device 1, the active-matrix substrate 10b and source substrates 160 experience significantly different amounts of expansion or contraction due to the difference in linear expansion coefficient. As a result, the positions at which these substrates are connected with the source driver 140 may be displaced in the y direction, for example. Then, the degree of bend of each of the first and second flexible regions 141a and 141b of each source driver 140 changes depending on this displacement, absorbing the stress in the source driver 140.

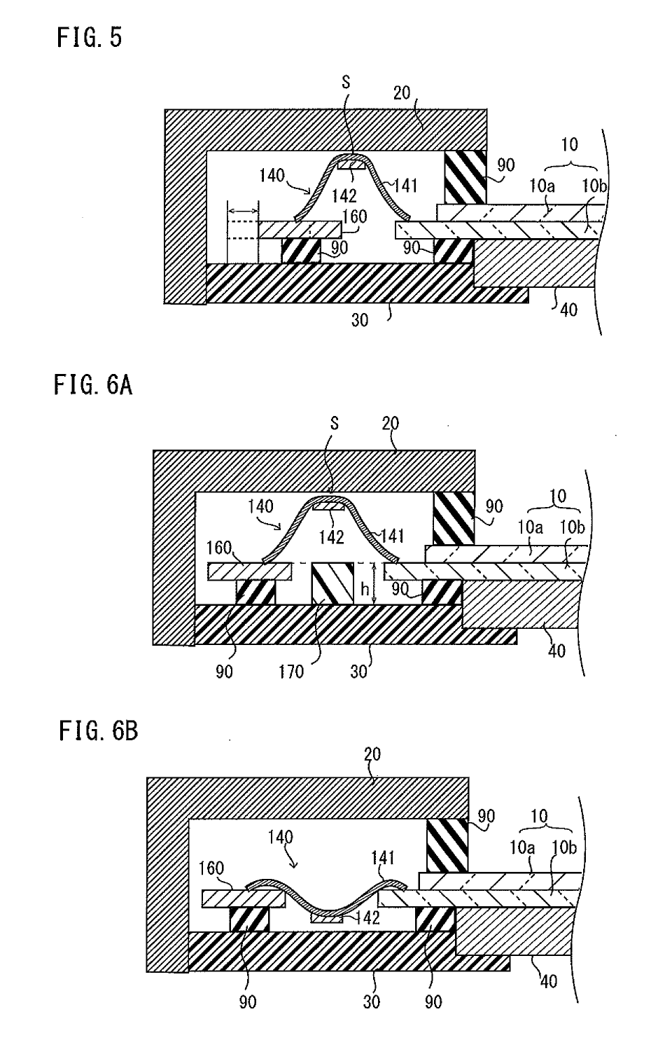

In the above embodiment, the first and second flexible regions 141a and 141b are curved such that the IC chip 142 portion protrudes toward the bezel 20. That is, the display device 1 is constructed in such a way that the opposite edges of each source driver 140 are fixed to the associated source driver 160 and the display panel 10 and still capable of following the displacement of the source substrate 160 and display panel 10. Thus, when the source substrate 160 and/or display panel 10 are thermally expanded or contracted due to changes in the temperature inside the display device 1, stress that is thus applied to the source driver 140 is absorbed. This prevents the source driver 140 from being broken or lines from snapping. Further, in the display device 1, each IC chip 142 is located more distant from the backlight 40 than in an implementation where each source substrate and the display panel are connected via a source driver that is not folded but is flat. Thus, the IC chip 142 is less likely to be affected by heat from the backlight 40, which prevents the IC chip 142 from being broken. Further, it is possible to reduce the distance between the source substrate 160 and active-matrix substrate 10b by moving the source substrate 160 of FIG. 2 toward the active-matrix substrate 10b, as indicated by broken lines in FIG. 5, for example. This advantageously reduces the breadth of the picture frame even though each source substrate 160 and active-matrix substrate 10b are connected in a flat manner.

### Second Embodiment

FIG. 6A shows the connection arrangement of the present embodiment. Similar to the first embodiment, the present embodiment includes source drivers 140 each connected with the associated source substrate 160 and the active-matrix substrate 10b, where the IC chip 142 portion protrudes toward the bezel 20.

In the present embodiment, ribs 170 are fixed on the chassis 30, each located below an IC chip 142 and between the associated source substrate 160 and active-matrix substrate 10b. Each rib 170 is in the shape of a cuboid. The rib 170 has such a height h that the upper surface of the rib 170 in this drawing is substantially level with the source substrate 160 and active-matrix substrate 10b.

The bezel 20 and each rib 170 need not sandwich the associated source driver 140 in such a way that the IC chip 142 portion contacts the bezel 20. If the rib 170 and bezel 20 sandwiched the source driver 140, the source driver 140 would be fixed. In that case, the source driver 140 would not be able to follow a displacement of the source substrate 160 and/or display panel 10. In view of this, the rib 170 suitably has such a height that its top is substantially level with the source substrate 160 and active-matrix substrate 10b or greater and that is smaller than the distance between the chassis 30 and bezel 20.

For example, when source drivers 140 are incorporated into a display device 1, an IC chip 142 portion may be warped away from the bezel 20, as shown in FIG. 6B. In such a case, this IC chip 142 is likely to be affected by heat from the backlight 40. If a rib 170 is provided, the IC chip 142 portion is pushed toward the bezel 20, and the tension in the film base 141 warps the source driver 140 toward the bezel 20. This eliminates the possibility that an IC chip 142 is located lower than the source substrate 160 and active-matrix substrate 10b, as shown in FIG. 6B. Thus, the IC chip 142 is unlikely to be affected by heat from the backlight 40, preventing the IC chip 142 from being damaged.

### Third Embodiment

In the first embodiment above, each IC chip 142 portion is not in contact with the bezel 20. The present embodiment illustrates an implementation where each IC chip 142 portion is in contact with the bezel 20.

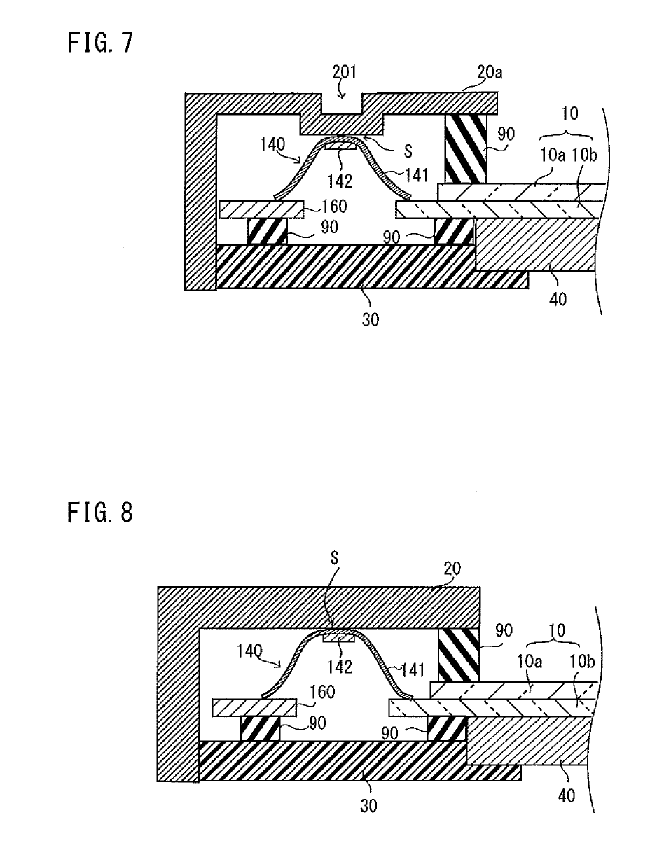

FIG. 7 shows a cross-section of the display device 1 of the present embodiment. As shown in FIG. 7, in the present embodiment, a recessed portion 201 is formed in the bezel 20a. The recessed portion 201 is positioned to face the IC chip 140 portions when the source drivers 140 are connected with the source substrates 160 and active-matrix substrate 10b, and protrudes toward the back of the display panel 10 and its side at the front side of the bezel 20 is recessed. The side of the recessed portion 201 that protrudes toward the display panel 10, i.e. the back side of the recessed portion 201, is in contact with the IC chip 142 portions. In this arrangement, heat generated from an IC chip 142 is transferred to the recessed portion 201, which is in contact with the IC ship 142 portion, such that heat is dissipated to the bezel 20.

While embodiments of the present invention have been described, the above embodiments are merely illustrative examples useful in carrying out the present invention. Therefore, the present invention is not limited to the above embodiments and, to carry out the invention, the above embodiments may be modified as appropriate without departing from the spirit of the invention. Variations of the present invention will be described below.

(1) In the third embodiment above, a recessed portion 201 is formed in the bezel 20 and each IC chip 142 portion is in contact with the side of the recessed portion 201 that protrudes toward the display panel 10. This arrangement may be modified in one of the following manners. For example, as shown in FIG. 8, the length of each source driver 140 may be adjusted such that the IC chip 142 portions are in contact with a bezel 20 that is similar to that of the first embodiment, or the height of the bezel 20 may be adjusted. Alternatively, a radiator sheet may be inserted between the bezel 20 and the IC chip 142 portions to adjust the height of these portions. This arrangement will cause heat generated by an IC chip 142 to dissipate to the bezel 20 through the IC chip 142 portion.

(2) In the second embodiment above, the bezel 20 may be replaced by the bezel 20a of the third embodiment. Further, in the variations in (1) above, ribs 170 similar to those of the second embodiment may be provided. When source drivers 140 are incorporated into a display device 1, an IC chip 142 portion may be warped away from the bezel 20, as shown in FIG. 6B, in which case the IC chip 142 portion is not in contact with the bezel 20, which means that heat generated by the IC chip 142 may not be dissipated. As ribs 170 are provided, each IC chip 142 portion is pushed toward the bezel 20a such that the IC chip 142 portion is in contact with the bezel 20a. As a result, heat generated by an IC chip 142 may be dissipated to the bezel 20a.

(3) In the second embodiment and variations in (2) above, the chassis 30 and ribs 170 are separate components; alternatively, the chassis 30 and ribs 170 may be integrally formed.

(4) The first to third embodiments above illustrate examples of connection arrangements for the source drivers 140; additionally, the gate drivers 130 may be connected with the gate substrate 150 and active-matrix substrate 10b in a manner similar to that for the source drivers 140 illustrated above.

(5) In the first to third embodiments above, the bezel 20 or 20a is made of metal; alternatively, it may be made of an insulating resin with a suitable thermal conductivity. Further, an insulating radiator sheet with a suitable heat conductivity may be attached to the portions of the inner side of the bezel 20 or 20a that are in contact with the IC chip 142 portions such that heat generated by the IC chips 142 may be dissipated.

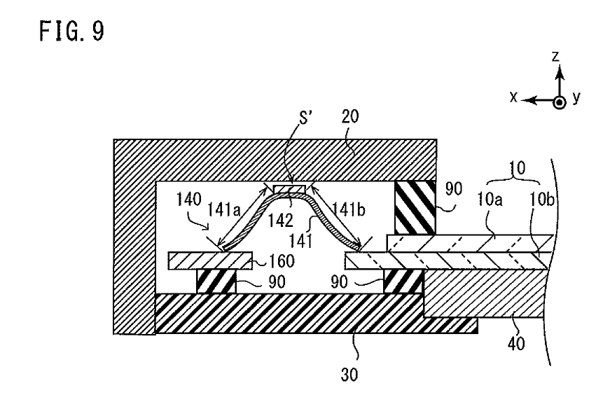

(6) In the first to third embodiments above, each IC chip 142 is located on the side of the driver that is opposite that at the display surface; alternatively, the display panel 10 may be connected with the source substrates 160 via source drivers that each have an IC chip 142 located on the side at the display surface. FIG. 9 shows a connection arrangement for a source driver 140 according to this variation. As shown in FIG. 9, the portion S′ of the side of the film base 141 on which the IC chip 142 is provided may protrude toward the bezel 20. In this variation, the IC chip 142 portion is the portion S′ of the side of the film base 141 on which the IC chip 142 is provided.

In the implementation of FIG. 9, the IC chip 142 portion is not in contact with the bezel 20; alternatively, the IC chip 142 portion may be in contact with the inner side of the bezel 20. Further, a connection arrangement similar to that for the source drivers 140 of this variation may be used for the gate drivers 130, as in the variation in (4), such that the bezel 20 is in contact with the IC chip 132 portions. The surface of the IC chip 142 of a source driver 140 has a GND voltage, while the surface of the IC chip 132 of a gate driver 130 has a gate low voltage. In view of this, if this arrangement is used for the gate drivers 130, an insulator may be provided between the bezel 20 and IC chips 132.

(7) The source drivers 140, source substrates 160 and display panel 10 of any one of the first to third embodiments above may function as a display module.

(8) Each of the first to third embodiments above illustrates a liquid crystal display device; alternatively, an organic electroluminescent display device may be used, for example.

### INDUSTRIAL APPLICABILITY

The present invention is industrially useful in a display panel and a display device including a driving circuit for driving a display panel. Preliminary Amendment

1. A display module comprising:
a display panel;
a circuit substrate positioned to be substantially level with the display panel;
a line substrate, the line substrate being flexible, the line substrate having one edge connected with the display panel and an opposite edge connected with the circuit substrate; and
a driver provided between the one edge and the opposite edge of the line substrate for driving the display panel,
wherein, in a connection state in which the line substrate is connected with the display panel and the circuit substrate, a first flexible region between the edge and the driver and a second flexible region between the opposite edge and the driver are bent and a portion of the line substrate on which the driver is located protrudes toward a front of the display panel.

2. The display module according to claim 1, wherein a rib is provided below the portion of the line substrate on which the driver is located and between the display panel and the circuit substrate.

3. The display module according to claim 2, wherein the rib is provided so as to have its upper surface located substantially level with the display panel and the circuit substrate.

4. The display module according to claim 1, wherein:
the display panel is sandwiched by a first frame element covering an outer periphery of a front side of the display panel and a second frame element covering an outer periphery of a back side of the display panel; and,
in the connection state, the driver portion is in contact with the first frame element.

5. The display module according to claim 4, wherein:
the first frame element includes a recessed portion positioned to correspond to the driver portion with a front side that is recessed and a back side that protrudes toward a back of the display panel; and,
in the connection state, the driver portion is in contact with the back side of the recessed portion.

6. The display module according to claim 2, wherein the rib is formed integrally with the second frame element.

7. The display module according to claim 1, wherein:
the circuit substrate transmits a signal from a control circuit to the line substrate; and
the driver has a source circuit configured to supply a data signal based on the signal from the circuit substrate to the display panel via a first connection terminal.

8. The display module according to claim 7, further comprising:
a gate circuit substrate connected with the display panel and configured to supply a scan signal based on a signal from the control circuit to the display panel.

9. A display device comprising:
a control circuit configured to provide a signal for driving the display panel; and
the display module according to claim 1.
